(19) United States
(12) Patent Application Publication
(10) Pub. No.: US 2019/0070507 A1
(43) Pub. Date: Mar. 7, 2019

(54) REFLECTING USER REAL-WORLD PERFORMANCE OF PRACTICE IN AVATAR OF VIDEO GAME

(71) Applicant: William Van Deren, Fitchburg, WI (US)

(72) Inventor: William Van Deren, Fitchburg, WI (US)

(21) Appl. No.: 15/697,721

(22) Filed: Sep. 7, 2017

(51) Int. Cl. A63F 13/65; A63F 13/213; A63F 13/816; A63F 13/69; A63F 13/85

(52) U.S. Cl. CPC A63F 13/65; A63F 13/213; A63F 13/85; A63F 13/69; A63F 13/816

(57) ABSTRACT

A computer-implemented method, apparatus, and medium for reflecting a user's real-world performance of a practice in an avatar of a video game are described. A plurality of practices to be performed by the user in real world is provided, an indication that the user has completed a practice of the plurality of practices in the real world is received, a characteristic of the avatar corresponding to the practice is upgraded in response to receiving the indication, and the avatar is provided in the video game based on the upgraded characteristic. Accordingly, a user is able to view the avatar as an expression of the user's own personal growth and skill development in real life because the avatar's progress corresponds directly to actual practices performed by the user in real life, which encourages a deep and long-term evolution of various practices and provides engaging rewards that have tangible benefits in the real world and the virtual world.

### BACKGROUND

### 1. Technical Field

The present disclosure relates generally to the field of video gaming. More particularly, the present disclosure relates to reflecting a user's real-world performance of a practice in an avatar of a video game.

### 2. Description of Related Art

Modern life is difficult for many people; some have excess stress while others struggle to find direction or meaning in their lives. Science has shown that meditation and related practices boost energy levels, reduce stress, improve mood, and raise overall quality of life, and many people are turning to these practices to improve their lives.

Spiritual and religious traditions have existed in various forms all over the world for millennia. Traditionally, one would need to dedicate one's life, or at least a significant amount of time, to a spiritual or religious group to learn these traditions. Meditation and yoga groups are now more prevalent and more accessible, but most are restricted to teaching a limited type or types of practices rather than making available the whole breadth of human knowledge. Additionally, few of these groups that are deeply knowledgeable in their disciplines make their practices available to the public. While there are resources about these practices available in books and online, these resources tend to be scattered and do not contain a model for long-term growth.

Current attempts have been made to create software applications that facilitate these types of practices. However, these applications often reduce centuries of tradition and refinement in these practices into a single practice or small group of practices, and do not offer comprehensive programs that develop over time or allow for long-term progression and growth. Additionally, while the applications may offer tools to facilitate continued practice, such as reminder notifications or to-do lists, the applications do not change the practices over time and do not simulate the journeys of users as they develop. For example, an application may include a to-do list of user-generated tasks (e.g., practices) to complete, but completion of a task merely causes a check mark to appear next to the task without a more engaging reward.

Based on the foregoing, there is a need in the art for an improved system of teaching spiritual and personal development practices in a manner that allows users to selectively and conveniently hone in on specific disciplines or expand the breadth of their practices to a wide variety of disciplines. There is also a need in the art for an improved means of encouraging long-term growth by reflecting personal progress in a more engaging manner.

The above problems in the related art are considered as matters that have been addressed by the inventor to derive the present inventive concept, or as matters discovered during the course of deriving the present inventive concept. Thus, the problems may not be simply referred to as information that was known to the general public prior to filing the present disclosure.

### SUMMARY OF EMBODIMENTS

Various embodiments of the present disclosure include a computer-implemented method for reflecting a user's real-world performance of a practice in an avatar of a video game, the method including providing, by a computer, the video game comprising a plurality of practices to be performed by the user in real world; receiving, by the computer, an indication that the user has completed a practice of the plurality of practices in the real world; upgrading, by the computer, a characteristic of the avatar corresponding to the practice in response to receiving the indication; and providing, by the computer, the avatar in the video game based on the upgraded characteristic.

In an exemplary embodiment, the method may include determining that a first threshold has been exceeded based on the indication, wherein the upgrading further comprises upgrading the characteristic of the avatar in response to the determination that the first threshold has been exceeded.

In an exemplary embodiment, the method may include incrementing a total number of completions of the practice by the user based on the indication; and comparing the total number of completions of the practice by the user to the first threshold, wherein the first threshold corresponds to a predetermined number of completions of the practice.

In an exemplary embodiment, the method may include receiving an indication of an effectiveness in which the user has completed the practice; incrementing a total number of experience points in the characteristic based on the indication that the user has completed the practice and the indication of the effectiveness with which the user has completed the practice; and comparing the total number of experience points in the characteristic to the first threshold, wherein the first threshold corresponds to a predetermined number of experience points in the characteristic.

In an exemplary embodiment, the characteristic may be an attribute of the avatar or an ability of the avatar.

In an exemplary embodiment, the plurality of practices may include at least one unlocked practice accessible to the user and at least one locked practice inaccessible to the user, the method may include determining that a second threshold has been exceeded for the practice based on the indication; and unlocking at least one of the at least one locked practice in response to the determination that the second threshold has been exceeded.

In an exemplary embodiment, the method may include assigning a total mastery level of the practice by the user based on at least one of a total number of completions of the practice by the user and an effectiveness of each completion of the practice by the user; and comparing the total mastery level of the practice by the user to the second threshold, wherein the second threshold corresponds to a predetermined mastery level of the practice, and wherein the practice is a prerequisite to the at least one of the at least one locked practice.

In an exemplary embodiment, the plurality of practices may include at least one of yoga, meditation, Kundalini exercise, physical exercises, breathing exercises, nature meditations, willpower exercise, creative exercise, intellectual exercise, and occult exercise.

Various embodiments of the present disclosure include an apparatus including a processor; and a storage including computer readable code for reflecting a user's real-world performance of a practice in an avatar of a video game that, when executed by the processor, cause the processor to provide the video game comprising a plurality of practices to be performed by the user in real world; receive an indication that the user has completed a practice of the plurality of practices in the real world; upgrade a characteristic of the avatar corresponding to the practice in response to receiving the indication; and provide the avatar in the video game based on the upgraded characteristic.

In an exemplary embodiment, the storage may include instructions that, when executed by the processor, cause the processor to determine that a first threshold has been exceeded based on the indication, wherein the upgrading further comprises upgrading the characteristic of the avatar in response to the determination that the first threshold has been exceeded.

In an exemplary embodiment, the storage may include instructions that, when executed by the processor, cause the processor to increment a total number of completions of the practice by the user based on the indication; and compare the total number of completions of the practice by the user to the first threshold, wherein the first threshold corresponds to a predetermined number of completions of the practice.

In an exemplary embodiment, the storage may include instructions that, when executed by the processor, cause the processor to receive an indication of an effectiveness in which the user has completed the practice; increment a total number of experience points in the characteristic based on the indication that the user has completed the practice and the indication of the effectiveness with which the user has completed the practice; and compare the total number of experience points in the characteristic to the first threshold, wherein the first threshold corresponds to a predetermined number of experience points in the characteristic.

In an exemplary embodiment, the characteristic may be an attribute of the avatar or an ability of the avatar.

In an exemplary embodiment, the plurality of practices may include at least one unlocked practice accessible to the user and at least one locked practice inaccessible to the user, and the storage may include instructions that, when executed by the processor, cause the processor to determine that a second threshold has been exceeded for the practice based on the indication; and unlock at least one of the at least one locked practice in response to the determination that the second threshold has been exceeded.

In an exemplary embodiment, the storage may include instructions that, when executed by the processor, cause the processor to assign a total mastery level of the practice by the user based on at least one of a total number of completions of the practice by the user and an effectiveness of each completion of the practice by the user; and compare the total mastery level of the practice by the user to the second threshold, wherein the second threshold corresponds to a predetermined mastery level of the practice, and wherein the practice is a prerequisite to the at least one of the at least one locked practice.

In an exemplary embodiment, the plurality of practices may include at least one of yoga, meditation, Kundalini exercise, physical exercises, breathing exercises, nature meditations, willpower exercise, creative exercise, intellectual exercise, and occult exercise.

Various embodiments of the present disclosure include a non-transitory computer readable medium storing computer-executable instructions for reflecting a user's real-world performance of a practice in an avatar of a video game that, when executed by a computer, cause the computer to provide the video game comprising a plurality of practices to be performed by the user in real world receive an indication that the user has completed a practice of the plurality of practices in the real world determine that a first threshold has been exceeded based on the indication upgrade a characteristic of the avatar corresponding to the practice in response to the determination that the first threshold has been exceeded; and provide the avatar in the video game based on the upgraded characteristic.

In an exemplary embodiment, the non-transitory computer readable medium may include instructions that, when executed by the computer, cause the computer to increment a total number of completions of the practice by the user based on the indication; and compare the total number of completions of the practice by the user to the first threshold, wherein the first threshold corresponds to a predetermined number of completions of the practice.

In an exemplary embodiment, the non-transitory computer readable medium may include instructions that, when executed by the computer, cause the computer to receive an indication of an effectiveness in which the user has completed the practice; increment a total number of experience points in the characteristic based on the indication that the user has completed the practice and the indication of the effectiveness with which the user has completed the practice; and compare the total number of experience points in the characteristic to the first threshold, wherein the first threshold corresponds to a predetermined number of experience points in the characteristic.

In an exemplary embodiment, the plurality of practices may include at least one unlocked practice accessible to the user and at least one locked practice inaccessible to the user, and the non-transitory computer readable medium may include instructions that, when executed by the computer, cause the computer to assign a total mastery level of the practice by the user based on at least one of a total number of completions of the practice by the user and an effectiveness of each completion of the practice by the user; compare the total mastery level of the practice by the user to a second threshold; determine that the second threshold has been exceeded for the practice based on the comparison; and unlock at least one of the at least one locked practice in response to the determination that the second threshold has been exceeded, wherein the second threshold corresponds to a predetermined mastery level of the practice, and wherein the practice is a prerequisite to the at least one of the at least one locked practice.

The foregoing, and other features and advantages, will be apparent from the following, more particular description of the exemplary and preferred embodiments, the accompanying drawings, and the claims.

### BRIEF DESCRIPTION OF THE DRAWINGS

The present disclosure will become more fully understood from the specification and the accompanying drawings, wherein:

FIG. 1 is a functional block diagram illustrating a system architecture according to various embodiments.

FIG. 2 is a flowchart illustrating a method according to various embodiments.

FIG. 3 is a flowchart illustrating additional method steps according to various embodiments.

### DETAILED DESCRIPTION OF EMBODIMENTS

The following description is merely exemplary in nature and is in no way intended to limit the various embodiments, their application, or uses. It should be understood that the terminology used herein is used for the purpose of describing particular embodiments only, and is not intended to limit the scope of the present disclosure. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may. Features that are described in the context of separate embodiments may also be provided in combination in a single embodiment. Conversely, various features that are, for brevity, described in the context of a single embodiment, may also be provided separately or in any suitable subcombination. New claims may be formulated to such features and/or combinations of such features during the prosecution of the present application or of any further application derived therefrom.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the various embodiments of the present disclosure. Structures described herein are to be understood also to refer to functional equivalents of such structures.

It should be understood that steps within a method may be executed in different order without altering the principles of the present disclosure. Additionally, the components and/or elements recited in any apparatus or system claim may be assembled or otherwise operationally configured in a variety of permutations and are accordingly not limited to the specific configuration recited in the claims.

The drawings described herein are for illustrative purposes only of selected embodiments and not all possible implementations, and are not intended to limit the scope of any of the various embodiments disclosed herein or any equivalents thereof. It is understood that the drawings are not drawn to scale. For purposes of clarity, the same reference numbers will be used in the drawings to identify similar elements.

Exemplary embodiments will now be described in detail with reference to the accompanying drawings.

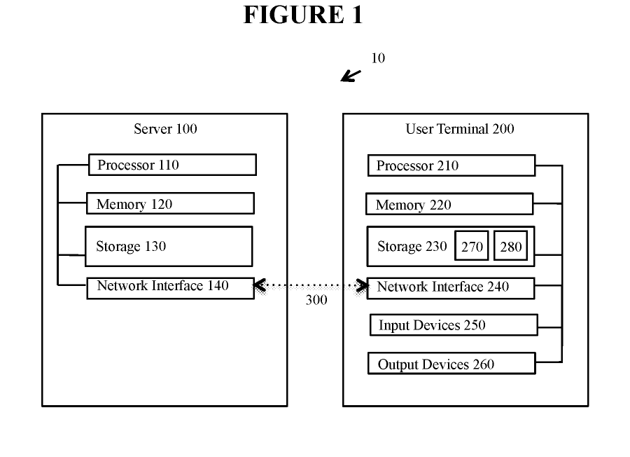

FIG. 1 is a functional block diagram illustrating a video gaming system architecture according to various embodiments.

Referring to FIG. 1, a video gaming system 10 includes a game server 100 and a user terminal 200 connected to the game server 100 through a network 300. The game server 100 that is connected to the user terminal 200 may provide a video game and/or game content through the network 300 to the user terminal 200. Further, a user may operate the user terminal 200 to play the video game provided by the game server 100, and the game content may be reflected in the video game as it is played from the user terminal 200.

According to various embodiments, the game server 100 may include a processor 110, a memory 120, a storage 130, and a network interface 140. The processor 110 in conjunction with the memory 120 may execute a program stored in the storage 130 to provide the functions of the game server 100 described herein. The network interface 140 may be functionally connected to the processor 110 and may be configured to transmit and/or receive information for the game server 100 via a wireless or wired network, such as network 300. For example, the game server 100 may be in communication with the user terminal 200 via network interface 140. The game server 100 may also be in communication with other user terminals or servers (not shown) via network interface 140.

Similarly, according to various embodiments, the user terminal 200 may include a processor 210, a memory 220, a storage 230, a network interface 240, input devices 250, and output devices 260. The processor 210 in conjunction with the memory 220 may execute a program stored in the storage 230 to provide the functions of the user terminal 200 described herein. For example, the processor 210 may execute a game application 270 stored in the storage 230 to play the video game provided by game server 100. The game application 270 may be executed in conjunction with game data 280 to provide standard and/or enhanced features or game content to game play.

The network interface 240 may be functionally connected to the processor 210 and may be configured to transmit and/or receive information for the user terminal 200 via a wireless or wired network, such as network 300. For example, the user terminal 200 may be in communication with the game server 100 via network interface 240 to receive the game application 270 and/or game data 280 to be stored in the storage 230. The network interface may be through a cellular provider, wireless local area network or other communications protocol, such as Bluetooth or IrDA, or wired connection, such as Ethernet.

In one embodiment, the game application 270 and/or the game data 280 may be resident or pre-installed on the user terminal 200. In one embodiment, the game application 270 and/or the game data 280 may be loaded, downloaded, or installed on the user terminal 200. In one embodiment, a portion of the game application 270 and/or the game data 280 may be resident or pre-installed on the user terminal 200 and the remainder of the game application 270 and/or the game data 280 may be loaded, downloaded, or installed on the user terminal 200 at a later point in time, such as, for example, upon connection to the game server 100, or upon payment for use of the game application 270 and/or the game data 280, or held temporarily on the user terminal 200 based on a subscription.

In some embodiments, input devices 250 may provide user input capability to the user terminal 200 and may include a touchscreen, a keypad, a keyboard, a trackball, a mouse, a game controller, a microphone, a voice command, and/or other user input device.

In some embodiments, output devices 260 may provide user output capability to the terminal 200 and may include a display, speaker(s), vibration device, and/or other user output device.

In some embodiments, the user terminal 200 may be a smartphone, a mobile phone, a cellular phone, a PDA, a tablet computer, a netbook computer, a personal pocket computer, a laptop computer, a desktop computer, an iPad, an Android based tablet, or any similar device now known or developed in the future.

As discussed above, various embodiments disclosed herein relate to a video game system and a user operating a user terminal 200 to play a video game, such as role playing game. In particular, the game application 270 may be executed to present and give control to a user of an avatar in a virtual world. For example, the user may interact with the virtual world, including other avatars, non-player characters, objects, items, enemies, monsters, etc., through the controlled actions of the user's avatar. The user may manipulate the avatar's actions via the input devices 250. For example, the user may directly control an avatar's movement or action by pressing a corresponding button or virtual button, or the user may control an avatar's movement or action by selecting from a menu.

An avatar has attributes that define its capabilities in various aspects. Each attribute has a corresponding value, such as a number, that may indicate how the avatar will interact with elements of the video game. For example, an attribute may represent a resource pool that may be expended and replenished, or may represent the avatar's capacity to perform certain actions. Table 1 illustrates non-limiting examples of an avatar's attributes as well as exemplary descriptions of how each attribute may be used in the video game.

TABLE 1

| Attribute | Description |
|---|---|
| Health | Overall amount of hit points |
| Strength | Physical attack |
| Endurance | Physical defense |
| Dexterity | Allows the ability to wield certain weapons |
| Emotional/Energetic | Overall strength of magic attacks |
| Will (Mana Pool) | Overall amount of mana points |
| Empathy | Determines how many people can be in party, effectiveness of |
| | healing spells and team bonuses, and social effectiveness of power of |
| | influence magic |
| Expression | Increases effectiveness of art spells meant to accomplish other |
| | effects, and grants ability to craft, upgrade, and/or share practices |
| Vision/Understanding | Boosts effectiveness of any procedure that requires visualization, and |
| | grants ability to see certain things and complete certain spells |
| Attention/Focus | Used to unlock abilities or practices that need to be learned, and acts |
| | as multiplier that determines effectiveness of any practice except for |
| | meditation |

An avatar may also have abilities that are actions that may be performed in the video game. Abilities may correspond to spells that may be performed by the avatar, or abilities may provide temporary or bonus effects to the avatar, the avatar's attributes, or other elements of the video game. For example, an ability may be a visualization of a shield around the avatar to provide the avatar a defensive bonus in combat or may grant the avatar to certain skills such as the ability to unlock doors or use certain elemental attacks, healing spells, and spells to analyze enemy strength. Table 2 illustrates non-limiting examples of an avatar's abilities as well as exemplary descriptions of how each ability may be used in the video game.

TABLE 2

| Ability | Description |
|---|---|
| Simple | Basic spells or skills that typically involve few steps and |
| Abilities | provide the avatar with a certain effect |
| Complex | One-time use abilities that typically require multiple steps |
| Abilities | and willpower, and are more powerful than Simple Abilities |
| Combat | Used in place of a turn in combat to provide an in-battle |
| Abilities | benefit such as inflicting damage or an increase in certain |
| | attributes, in some cases at a cost of Will, and provides a |
| | smaller effect than Simple Abilities |
| Quick Fixes | Combat abilities performed outside of battle for quick |
| | corrections or boosts to certain attributes |

Attributes may be upgraded by gaining in-game experience, such as by defeating an enemy or completing an objective. However, attributes may also be upgraded by performing certain activities in real life, such as practices or courses. Similarly, abilities may be “locked” as unavailable to the avatar, but may be upgraded and “unlocked” as available to the avatar by gaining in-game experience or by performing practices and/or courses. In an exemplary embodiment, attributes and/or abilities may only be upgraded or unlocked by performing practices or courses.

Practices are individual tasks that are performed in real life by the user to provide a certain benefit. For example, practices may include, but are not limited to, meditation sessions, energy harnessing exercises, yoga or Kundalini exercises, physical exercises, breathing exercises, nature meditations, working with oils, herbs, and incense, summoning various entities/spirits, willpower exercises, visualization exercises, creative exercises such as art or music, and intellectual or occult exercises.

Courses are groups of practices that are intended to teach a user a particular skill. Courses are structured in a hierarchical format, such as technology tree, such that certain practices must be completed in a certain order to complete a given course. In some embodiments, a given practice of a course may be “locked” as inaccessible to a user, where the user must complete prerequisite practices to a certain degree to “unlock” the given practice as accessible to the user. For example, the user may be required to complete a prerequisite practice a predetermined number of times, or the user may be required to obtain a predetermined mastery of the prerequisite practice. The mastery level of the prerequisite practice may be assigned based on a total number of completions of the practice by the user, an effectiveness of each completion of the practice by the user, or both. In some embodiments, unlocking each practice in a course and/or completing each practice in a course to a predetermined mastery level(s) may cause an attribute or ability to be upgraded. Similarly, unlocking groups of courses and/or completing each course to a predetermined mastery level(s) may cause an attribute or ability to be upgraded.

In some embodiments, practices and courses may be developed by users and be made available to other users in the video game community. For example, user-generated practices and courses may be received, stored, and distributed by game server 100 to various user terminals, such as user terminal 200, after payment or subscription. Accordingly, a wide variety of practices can be made available to users.

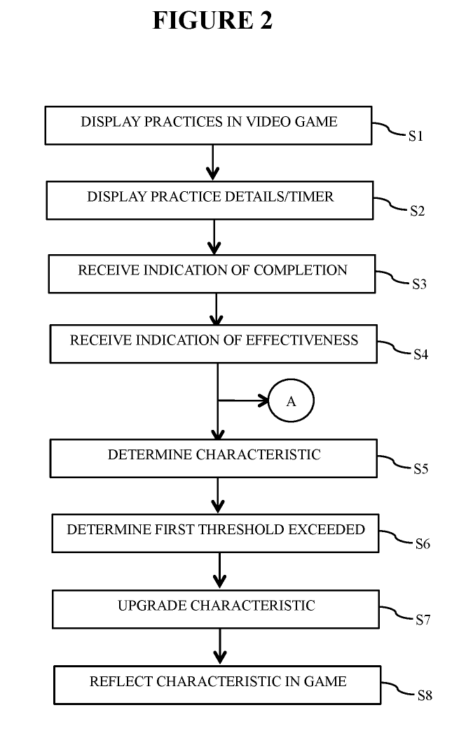

FIG. 2 illustrates a flowchart of a computer-implemented method according to various embodiments. For example, the method may be performed by user terminal 200.

Referring to FIG. 2, the method begins when a plurality of practices to be performed by the user in the real world are provided (step S1). In an exemplary embodiment, a list of courses and/or practices may be displayed for user selection. In another exemplary embodiment, courses and/or practices may correspond to locations on a map that is displayed. The user may navigate the list or map and select a desired course and practice using input devices 250. When a practice is selected by the user, details of the selected practice and a prompt to set a timer to begin the practice are displayed (step S2). Guided instruction may be turned on or off depending on user preference.

Then, an indication that the user has completed the selected practice is received, such as when the timer runs out or the user indicates that the selected practice is complete using the input devices 250 (step S3). In some embodiments, the user may also be prompted to rate the effectiveness of that instance of performing the selected practice, and an indication of the effectiveness with which the user has performed the selected practice is then received from the user (step S4).

In some embodiments, after receiving an indication that the user has completed the selected practice, a characteristic, such as an attribute or ability, of the avatar corresponding to the selected practice is determined (step S5). For example, Table 3 illustrates non-limiting examples of attributes and abilities corresponding to various practices.

TABLE 3

| Characteristic | |
|---|---|
| (Attribute/Ability) | Exemplary Corresponding Practices |
| Emotional/ | Energy harnessing exercises, yoga, Kundalini exercises |
| Energetic | |
| Will | Willpower exercises, visualization exercises |
| Empathy | Compassion or heart-centric meditation |
| Expression | Art, music, creative activities |
| Vision/ | Visualization exercises, intellectual exercises, occult |
| Understanding | exercises |
| Attention/Focus | Meditation |
| Simple Abilities | Basic meditation, inner fire visualization, compassion |
| | meditation |
| Complex Abilities | Basic meditation, inner fire visualization, compassion |
| | meditation |
| Quick Fixes | Centering meditation, energy raising visualization |
| | practice |

After determining a characteristic corresponding to the completed practice, a determination is made whether a first threshold has been exceeded (step S6). In an exemplary embodiment, this may include incrementing a total number of completions of the practice based on the most recent completion, and comparing a total number of completions of the practice by the user to a predetermined number of completions of the practice to determine that the first threshold has been exceeded. In another exemplary embodiment, determining whether the first threshold has been exceeded may include incrementing a total number of experience points in the characteristic based on the most recent completion of the practice, and comparing the total number of experience points in the characteristic to the a predetermined number of experience points in the characteristic to determine that the first threshold has been exceeded. The total number of experience points in the characteristic to be incremented may be based on completion of the practice and the effectiveness with which the user completed the practice. For example, completing a practice with more effectiveness may cause the total number of experience points to be incremented a greater amount that completing a practice with less effectiveness. A total number of experience points may be calculated for each attribute and each ability, and each total number of experience points may be compared to respective first thresholds to determine whether the corresponding attribute or ability is to be upgraded.

After determining that the first threshold has been exceeded, the characteristic corresponding to the practice is upgraded (step S7). In an exemplary embodiment, the characteristic may be an attribute of the avatar and upgrading the characteristic may cause the value (e.g., number) of the attribute to be increased by a predetermined amount. In another exemplary embodiment, the characteristic may be an ability of the avatar and upgrading the characteristic may cause an ability “locked” as inaccessible to the user to become “unlocked” as accessible to the user, or upgrading the characteristic may cause a level of the ability of the avatar to be increased by a predetermined amount.

The avatar is then provided in the video game based on the upgraded characteristic (step S8). In other words, new or upgraded abilities and/or attributes are reflected as the avatar interacts with elements of the video game. For example, the avatar may newly be able to perform a spell to boost a combat attribute, or the existing spell to boost the combat attribute may be upgraded to boost the combat attribute at a greater extent.

Accordingly, a user's real-world performance of a practice is reflected in an avatar of the video game. A user is able to view the avatar as an expression of the user's own personal growth and skill development in real life because the avatar's progress corresponds directly to actual practices performed by the user in real life. This encourages a deep and long-term evolution of various practices and provides engaging rewards that have tangible benefits in the real world and the virtual world.

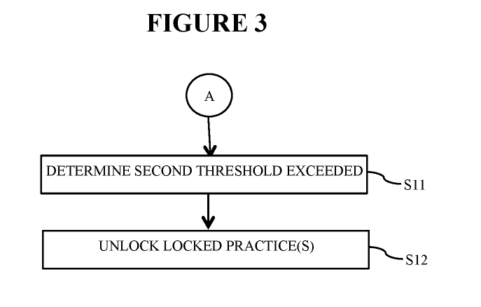

FIG. 3 illustrates a flowchart of additional method steps according to various embodiments.

As discussed above, in some embodiments, a given practice of a course may be “locked” as inaccessible to a user, where the user must complete prerequisite practices to a certain degree to “unlock” the given practice as accessible to the user. Referring to FIGS. 2 and 3, after receiving the indication that the user has completed the selected practice, and in some embodiments after receiving the indication of the effectiveness with which the user has performed the selected practice, it may be determined whether a second threshold has been exceeded for the practice based on the indication(s) (step S11). For example, the selected practice may be a prerequisite practice for a locked practice in the same course. In an exemplary embodiment, this may include assigning a total mastery level of the practice by the user based on the total number of completions of the practice by the user, the effectiveness of each completion of the practice by the user, or both, and comparing it to a predetermined mastery level of the practice to determine that the second threshold has been exceeded. After determining the second threshold has been exceeded, the locked practice is unlocked and is now accessible to the user (step S12).

In some embodiments, a locked practice may require a plurality of prerequisite practices to be completed at particular levels of mastery in order to unlock the locked practice. For example, Practice X must be at mastery level C and Practice Y must be at mastery level D in order to unlock Practice Z. Accordingly, in an exemplary embodiment, it may be determined whether all prerequisite practices are at required mastery levels before unlocking the locked practice.

Progression in the video game may require an avatar's attributes and abilities to be upgraded and unlocked as discussed above. Similarly, a user may be required to complete and unlock practices through various courses in order to obtain the necessary attributes and abilities to progress through the video game. Accordingly, by making such features integral to moving forward in the video game, users are more likely to engage with the self-actualization component of real-life practice, rather than practice being tangential to the game experience. These features act to translate the cumulative results of the practices into something that is useful to the user as a way of interacting with the video game, as a means for increasing the effectiveness of future practices, and as a way for the user to validate internally the progress made in life as a result of performing practices.

Embodiments may include various steps as set forth above. The steps may be embodied in computer-executable instructions that cause a general-purpose or special-purpose processor to perform certain steps. Various elements that are not relevant to these underlying principles such as computer memory, hard drive, and input devices may have been left out of some or all of the figures to avoid obscuring the pertinent aspects.

Elements of the disclosed subject matter may also be provided as a computer program product that may include a computer readable medium having stored thereon computer-executable instructions that may be used to program a computer (e.g., a processor or other electronic device) to perform a sequence of operations. Alternatively, the operations may be performed by a combination of hardware and software. The computer readable medium may include, but is not limited to, flash memory, optical disks, CD-ROMS, DVD ROMs, RAMs, EPROMs, EEPROMs, magnetic or optical cards, or other types of computer readable media suitable for storing instructions.

Additionally, although the disclosed subject matter has been described in conjunction with specific embodiments, numerous modifications and alterations are well within the scope of the present disclosure. Accordingly, the specification and drawings are to be regarded in an illustrative rather than a restrictive sense.

1. A computer-implemented method for reflecting a user's real-world performance of a practice in an avatar of a video game, the method comprising:
providing, by a computer, the video game comprising a plurality of practices to be performed by the user in real world;
receiving, by the computer, an indication that the user has completed a practice of the plurality of practices in the real world;
upgrading, by the computer, a characteristic of the avatar corresponding to the practice in response to receiving the indication; and
providing, by the computer, the avatar in the video game based on the upgraded characteristic.

2. The computer-implemented method according to claim 1, further comprising:
determining that a first threshold has been exceeded based on the indication,
wherein the upgrading further comprises upgrading the characteristic of the avatar in response to the determination that the first threshold has been exceeded.

3. The computer-implemented method according to claim 2, further comprising:
incrementing a total number of completions of the practice by the user based on the indication; and
comparing the total number of completions of the practice by the user to the first threshold,
wherein the first threshold corresponds to a predetermined number of completions of the practice.

4. The computer-implemented method according to claim 2, further comprising:
receiving an indication of an effectiveness in which the user has completed the practice;
incrementing a total number of experience points in the characteristic based on the indication that the user has completed the practice and the indication of the effectiveness with which the user has completed the practice; and
comparing the total number of experience points in the characteristic to the first threshold,
wherein the first threshold corresponds to a predetermined number of experience points in the characteristic.

5. The computer-implemented method according to claim 1, wherein the characteristic is an attribute of the avatar or an ability of the avatar.

6. The computer-implemented method according to claim 1, wherein the plurality of practices comprises at least one unlocked practice accessible to the user and at least one locked practice inaccessible to the user, the method further comprising:
determining that a second threshold has been exceeded for the practice based on the indication; and
unlocking at least one of the at least one locked practice in response to the determination that the second threshold has been exceeded.

7. The computer-implemented method according to claim 6, further comprising:
assigning a total mastery level of the practice by the user based on at least one of a total number of completions of the practice by the user and an effectiveness of each completion of the practice by the user; and
comparing the total mastery level of the practice by the user to the second threshold,
wherein the second threshold corresponds to a predetermined mastery level of the practice, and
wherein the practice is a prerequisite to the at least one of the at least one locked practice.

8. The computer-implemented method according to claim 1, wherein the plurality of practices comprises at least one of yoga, meditation, Kundalini exercise, physical exercises, breathing exercises, nature meditations, willpower exercise, creative exercise, intellectual exercise, and occult exercise.

9. An apparatus comprising:
a processor; and
a storage comprising computer readable code for reflecting a user's real-world performance of a practice in an avatar of a video game that, when executed by the processor, cause the processor to:
provide the video game comprising a plurality of practices to be performed by the user in real world;
receive an indication that the user has completed a practice of the plurality of practices in the real world;
upgrade a characteristic of the avatar corresponding to the practice in response to receiving the indication; and
provide the avatar in the video game based on the upgraded characteristic.

10. The apparatus according to claim 9, wherein the storage further comprises instructions that, when executed by the processor, cause the processor to:
determine that a first threshold has been exceeded based on the indication,
wherein the upgrading further comprises upgrading the characteristic of the avatar in response to the determination that the first threshold has been exceeded.

11. The apparatus according to claim 10, wherein the storage further comprises instructions that, when executed by the processor, cause the processor to:
increment a total number of completions of the practice by the user based on the indication; and
compare the total number of completions of the practice by the user to the first threshold,
wherein the first threshold corresponds to a predetermined number of completions of the practice.

12. The apparatus according to claim 10, wherein the storage further comprises instructions that, when executed by the processor, cause the processor to:
receive an indication of an effectiveness in which the user has completed the practice;
increment a total number of experience points in the characteristic based on the indication that the user has completed the practice and the indication of the effectiveness with which the user has completed the practice; and
compare the total number of experience points in the characteristic to the first threshold,
wherein the first threshold corresponds to a predetermined number of experience points in the characteristic.

13. The apparatus according to claim 9, wherein the characteristic is an attribute of the avatar or an ability of the avatar.

14. The apparatus according to claim 9, wherein the plurality of practices comprises at least one unlocked practice accessible to the user and at least one locked practice inaccessible to the user, wherein the storage further comprises instructions that, when executed by the processor, cause the processor to:
determine that a second threshold has been exceeded for the practice based on the indication; and
unlock at least one of the at least one locked practice in response to the determination that the second threshold has been exceeded.

15. The apparatus according to claim 14, wherein the storage further comprises instructions that, when executed by the processor, cause the processor to:
assign a total mastery level of the practice by the user based on at least one of a total number of completions of the practice by the user and an effectiveness of each completion of the practice by the user; and
compare the total mastery level of the practice by the user to the second threshold,
wherein the second threshold corresponds to a predetermined mastery level of the practice, and
wherein the practice is a prerequisite to the at least one of the at least one locked practice.

16. The apparatus according to claim 9, wherein the plurality of practices comprises at least one of yoga, meditation, Kundalini exercise, physical exercises, breathing exercises, nature meditations, willpower exercise, creative exercise, intellectual exercise, and occult exercise.

17. A non-transitory computer readable medium storing computer-executable instructions for reflecting a user's real-world performance of a practice in an avatar of a video game that, when executed by a computer, cause the computer to:
provide the video game comprising a plurality of practices to be performed by the user in real world;
receive an indication that the user has completed a practice of the plurality of practices in the real world;
determine that a first threshold has been exceeded based on the indication;
upgrade a characteristic of the avatar corresponding to the practice in response to the determination that the first threshold has been exceeded; and
provide the avatar in the video game based on the upgraded characteristic.

18. The non-transitory computer readable medium according to claim 17, wherein the non-transitory computer readable medium further comprises instructions that, when executed by the computer, cause the computer to:
increment a total number of completions of the practice by the user based on the indication; and
compare the total number of completions of the practice by the user to the first threshold,
wherein the first threshold corresponds to a predetermined number of completions of the practice.

19. The non-transitory computer readable medium according to claim 17, wherein the non-transitory computer readable medium further comprises instructions that, when executed by the computer, cause the computer to:
receive an indication of an effectiveness in which the user has completed the practice;
increment a total number of experience points in the characteristic based on the indication that the user has completed the practice and the indication of the effectiveness with which the user has completed the practice; and
compare the total number of experience points in the characteristic to the first threshold,
wherein the first threshold corresponds to a predetermined number of experience points in the characteristic.

20. The non-transitory computer readable medium according to claim 17, wherein the plurality of practices comprises at least one unlocked practice accessible to the user and at least one locked practice inaccessible to the user, wherein the non-transitory computer readable medium further comprises instructions that, when executed by the computer, cause the computer to:
assign a total mastery level of the practice by the user based on at least one of a total number of completions of the practice by the user and an effectiveness of each completion of the practice by the user;
compare the total mastery level of the practice by the user to a second threshold;
determine that the second threshold has been exceeded for the practice based on the comparison; and
unlock at least one of the at least one locked practice in response to the determination that the second threshold has been exceeded,
wherein the second threshold corresponds to a predetermined mastery level of the practice, and
wherein the practice is a prerequisite to the at least one of the at least one locked practice.
